(19) United States
(12) Patent Application Publication
(10) Pub. No.: US 2024/0377696 A1
(43) Pub. Date: Nov. 14, 2024

(54) OPTICAL DEVICE

(71) Applicant: TDK CORPORATION, Tokyo (JP)

(72) Inventors: Hiroshi TAKE, Hong Kong (CN); Kenji NAGASE, Hong Kong (CN); Anthony Reymund Melad BINARAO, Hong Kong (CN); Cheng Bu HENG, Hong Kong (CN)

(73) Assignee: TDK CORPORATION, Tokyo (JP)

(21) Appl. No.: 18/293,020

(22) PCT Filed: Sep. 28, 2022
(86) PCT No.: PCT/JP2022/036290

§ 371 Date: Jan. 29, 2024

(30) Foreign Application Priority Data
Sep. 30, 2021 (CN) 202111160906.6

(51) Int. Cl. G02F 1/225; G02B 6/12; G02B 6/125; G02F 1/21

(52) U.S. Cl. CPC G02F 1/2257; G02B 6/12014; G02B 6/125; G02F 1/212; G02B 2006/1204; G02B 2006/12045; G02B 2006/12097

(57) ABSTRACT

An optical device, including a substrate and a plurality of optical waveguide paths formed on the substrate and having slab portions with different thicknesses.

### TECHNICAL FIELD

The present disclosure relates to an optical device used in the fields of optical communication and optical measurement.

### BACKGROUND ART

Communication traffic has been remarkably increased with widespread Internet use, and the optical fiber communication is becoming significantly important. The optical fiber communication is a technology that converts an electric signal into an optical signal and transmits the optical signal through an optical fiber. The optical fiber communication has wide bandwidth, low loss, and strong noise resistance.

FIG. 7 is a cross-sectional schematic view of an optical device 700 in the prior art. The optical device 700 has a substrate 710, optical waveguide paths 721, 722, 723 and a buffer layer 730. Light with three different wavelengths are propagated respectively in optical waveguide paths 721, 722, 723. However, in the optical device 700 in FIG. 7, when light with multiple wavelengths is incident, there is a concern that the propagation loss of each optical waveguide path will increase.

Patent Document 1 discloses an optical device having optical waveguide paths with different thicknesses. However, when light with multiple wavelengths is incident, a lower propagation loss is desired.

### CITATION LIST

### Patent Literature

PTL 1: Patent Document 1: JP Laid Open 2013-44805

### SUMMARY OF INVENTION

The present disclosure is completed in view of the above problems, and its object is to provide an optical device, comprising: a substrate and a plurality of optical waveguide paths formed on the substrate and comprising slab portions with different thicknesses. Thereby, the thickness of each optical waveguide path is different corresponding to the wavelength of the transmitted light, and the propagation loss of each optical waveguide path can be suppressed. And, it is possible to easily connect with the optical fiber and reduce the coupling loss by forming a plurality of optical waveguide paths on the substrate.

In addition, in the optical device of the present disclosure, preferably, the optical waveguide paths further comprise ridge portions, and among the plurality of optical waveguide paths, the thicknesses of the ridge portions are different. Thereby, the propagation loss of each optical waveguide path can be further suppressed.

In addition, in the optical device of the present disclosure, preferably, oxide layer covering the plurality of optical waveguide paths is formed. Therefore, the absorption of light propagating in the optical waveguide paths can be suppressed, and the propagation loss of each optical waveguide path can be further suppressed.

In addition, in the optical device of the present disclosure, preferably, the thickness of any of the slab portions is smaller than the thickness of any of the plurality of different ridge portions. Thereby, the propagation loss of each optical waveguide path can be further suppressed. Furthermore, a voltage can be easily applied to the optical waveguide paths by connecting on the thin slab portions, so that it is possible to facilitate the signal modulation and perform fine-tuning of color. In addition, since the ground electrode can be shared, the optical device can be miniaturized.

In addition, in the optical device of the present disclosure, preferably, the longer the wavelength of light transmitted at the corresponding ridge portion is, the lower the ratio of the thickness of the slab portion to the thickness of the ridge portion is. Thereby, light propagation of unnecessary mode can be suppressed, and the propagation loss of each optical waveguide path can be further suppressed.

In addition, in the optical device of the present disclosure, preferably, the thicknesses of the oxide layer on the ridge portions are equal.

In addition, in the optical device of the present disclosure, preferably, electrodes are provided on the oxide layer, and the electrodes are formed on a side surface of the oxide layer.

In addition, in the optical device of the present disclosure, preferably, the optical waveguide paths are formed of oxides containing lithium.

In addition, in the optical device of the present disclosure, preferably, the oxides containing lithium are epitaxially grown lithium niobate or lithium tantalite.

### ADVANTAGEOUS EFFECTS OF THE INVENTION

According to the optical device of the present disclosure, the propagation of multiple optical paths can be achieved in one device (chip), and the propagation loss of each optical waveguide path can be suppressed.

### BRIEF DESCRIPTION OF DRAWINGS

FIG. 1 is a top view of the optical device 100 of the first embodiment of the present disclosure.

FIG. 2 is an illustrative cross-sectional view of the optical device 100 taken along line A-A′ of FIG. 1.

FIG. 3 is an illustrative cross-sectional view of a modification 100A of the optical device 100 taken along line A-A′ of FIG. 1.

FIG. 4A-B are top views of the optical device 200 of the second embodiment of the present disclosure, and FIG. 4A only illustrates the optical waveguide.

FIG. 4A-B are top views of the optical device 200 of the second embodiment of the present disclosure, and FIG. 4B illustrates the optical device 200 including the travelling wave electrode as a whole.

FIG. 5 is an illustrative cross-sectional view of the optical device 200 taken along line B-B′ of FIG. 4B.

FIG. 6 is an illustrative cross-sectional view of a modification 200A of the optical device 200 taken along line B-B′ of FIG. 4B.

FIG. 7 is a schematic view of an optical device 700 in prior art.

### DESCRIPTION OF EMBODIMENTS

Hereinafter, embodiments of the present disclosure will be described in detail with reference to the accompanying drawings.

### First Embodiment

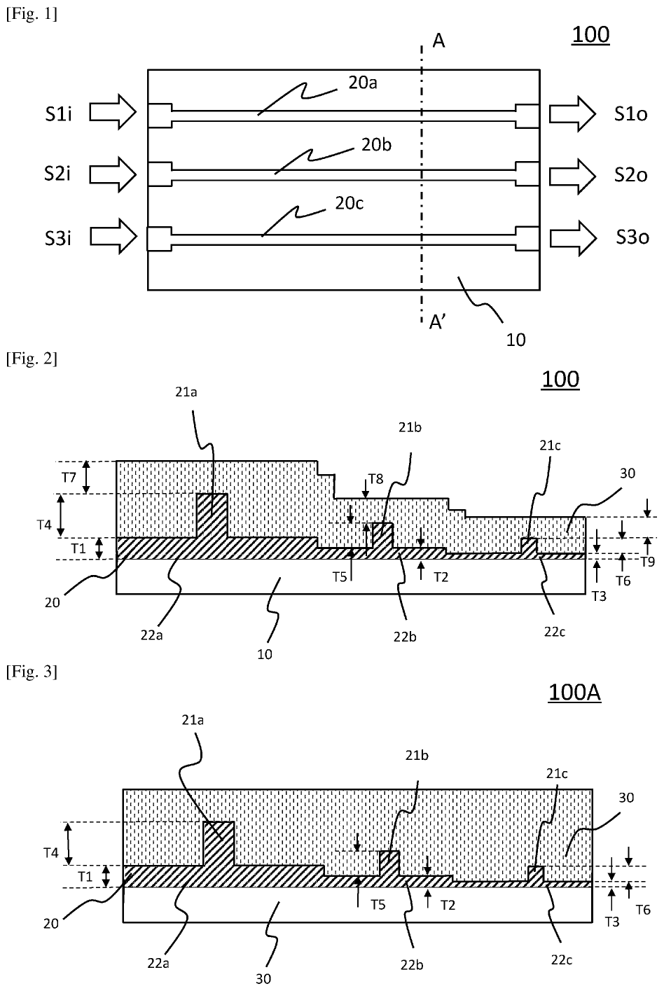

FIG. 1 is a top view of the optical device 100 of the first embodiment of the present disclosure. FIG. 2 is an illustrative cross-sectional view of the optical device 100 taken along line A-A′ of FIG. 1.

The optical device 100 illustrated in FIG. 1 and FIG. 2 comprises: a substrate 10, an optical waveguide layer 20 and a buffer layer 30. The optical waveguide layer 20 is composed of a lithium niobate film or a lithium tantalite film. The first visible light (for example, the red visible light), as an input signal S1i, is input into the optical device 100, and after propagating in the optical waveguide path 20a, it is output as an output signal S1o. The second visible light (for example, the green visible light), as an input signal S2i, is input into the optical device 100, and after propagating in the optical waveguide path 20b, it is output as an output signal S2o. The third visible light (for example, the blue visible light), as an input signal S3i, is input into the optical device 100, and after propagating in the optical waveguide path 20c, it is output as an output signal S3o. Thereby, the first visible light to the third visible light can be transmitted in one device (chip).

The substrate 10 is not particularly limited as long as it has a lower refractive index than the lithium niobate film constituting the optical waveguide layer 20, but it is preferably a substrate on which a lithium niobate film or a lithium tantalite film can be formed as an epitaxial film. Hereinafter, the lithium niobate film is described as an example. The substrate 10, for example, may be a single crystal substrate, such as a sapphire single crystal substrate, a silicon single crystal substrate, an aluminum oxide (Al₂O₃) single crystal substrate, or the like. The crystal orientation of the single crystal substrate is not particularly limited. The lithium niobate film constituting the optical waveguide layer 20 has properties such as being easily formed as a c-axis-oriented epitaxial film with respect to single crystal substrates having various crystal orientations. Since the c-axis oriented lithium niobate film has three-fold symmetry, the single crystal substrate used as the base, i.e. the substrate 10 also preferably has the same symmetry. When the substrate 10 is, for example, a sapphire single crystal substrate or an aluminum oxide single crystal substrate, it may be a substrate having a c-plane, and when the substrate 10 is a silicon single crystal substrate, it may be a substrate having an (111) surface.

The lithium niobate film constituting the optical waveguide layer 20 is formed of visible light-transmitting material containing lithium niobate. The visible light-transmitting material only needs to be transmissive for the visible light generated by the laser source 11, and it does not need to be transmissive for the entire region of the visible light.

Lithium niobate forming the lithium niobate film may contain elements other than lithium (Li), niobium (Nb) and oxygen (O). Lithium niobate may be a compound represented by the following formula (I).

LixNbAyOz (I)

In the formula (I), A denotes an element other than Li, Nb and O. Examples of the element A include K, Na, Rb, Cs, Be, Mg, Ca, Sr, Ba, Ti, Zr, Hf, V, Cr, Mo, W, Fc, Co, Ni, Zn, Sc, Ce etc., alone or in combination. The number x ranges from 0.5 to 1.2, preferably 0.9 to 1.05. The number y ranges from 0 to 0.5. The number z ranges from 1.5 to 4.0, preferably 2.5 to 3.5.

The optical waveguide layer 20 comprises the first optical waveguide path 20a, the second optical waveguide path 20b and the third optical waveguide path 20c. The first optical waveguide path 20a comprises the first ridge portion 21a and the first slab portion 22a. The second optical waveguide path 20b comprises the second ridge portion 21b and the second slab portion 22b. The third optical waveguide path 20c comprises the third ridge portion 21c and the third slab portion 22c. In the optical waveguide path composed of the ridge portion and the slab portion, the propagation of light is mainly concentrated on the ridge portion. In the optical device 100, the first ridge portion 21a becomes a main transmission path of propagating the first visible light (the red light) emitted by the laser source. The transmission direction of the first visible light in the first ridge portion 21a is the direction of propagating the first visible light. The second ridge portion 21b becomes a main transmission path of propagating the second visible light (the green light) emitted by the laser source. The transmission direction of the second visible light in the second ridge portion 21b is the direction of propagating the second visible light. The third ridge portion 21c becomes a main transmission path of propagating the third visible light (the blue light) emitted by the laser source. The transmission direction of the third visible light in the third ridge portion 21c is the direction of propagating the third visible light.

In order to suppress the propagation loss of each optical waveguide path, the thickness of the optical waveguide path may be set according to the wavelength of the transmitted light. As illustrated in FIG. 2, the thickness T3 of the third slab portion 22c is smaller than the thickness T2 of the second slab portion 22b, and the thickness T2 of the second slab portion 22b is smaller than the thickness T1 of the first slab portion 22a. In other words, the longer the wavelength of the light transmitted in the corresponding optical waveguide path is, the larger the thickness of the slab portion is. In addition, preferably, the thickness T6 of the third ridge portion 21c is smaller than the thickness T5 of the second ridge portion 21b, and the thickness T5 of the second ridge portion 21b is smaller than the thickness T4 of the first ridge portion 21a. In other words, the longer the wavelength of the light transmitted in the corresponding optical waveguide path is, the larger the thickness of the ridge portion is. Accordingly, the thickness of the optical waveguide paths 20a, 20b and 20c are different corresponding to the wavelength of the transmitted light, and the propagation loss of optical waveguide paths 20a, 20b and 20c can be suppressed. And, it is possible to easily connect with the optical fiber and reduce the coupling loss by forming a plurality of optical waveguide paths on the substrate 10.

In addition, preferably, the thickness T1 of the first slab portion 22a is smaller than the thickness T6 of the third ridge portion 21c. In other words, the thickness of the one with the largest thickness among the first slab portion 22a, the second slab portion 22b, and the third slab portion 22c is also smaller than the thickness of the smallest thickness among the first ridge portion 21a, the second ridge portion 21b, and the third ridge portion 21c. Accordingly, the propagation loss of each of optical waveguide paths 20a, 20b and 20c can be further suppressed.

In addition, preferably, the longer the wavelength of the light transmitted at the corresponding ridge portion is, the lower the ratio of the thicknesses of the slab portions to the thicknesses of the ridge portions. Specifically, the ratio of the thickness of the first slab portion 22a, which propagates the red light, to the thickness of the first ridge portion 21a (T1/T4) is smaller than or equal to the ratio of the thickness of the second slab portion 22b, which propagates the green light, to the thickness of the second ridge portion 21b (T2/T5), and the ratio of the thickness of the second slab portion 22b, which propagates the green light, to the thickness of the second ridge portion 21b (T2/T5) is smaller than or equal to the ratio of the thickness of the third slab portion 22c, which propagates the blue light, to the thickness of the third ridge portion 21c (T3/T6). Accordingly, the light propagation of unnecessary mode can be suppressed, and the propagation loss of each of the optical waveguide paths 20a, 20b and 20c can be further suppressed.

The thicknesses of the slab portions 22a to 22b of the optical waveguide layer 20 preferably ranges from 1 nm to 200 nm. Furthermore, the optical waveguide layer 20 is not necessary to comprise slab portions 22a, 22b and 22c, and it can be only composed of the ridge portions 21a, 21b and 21c.

The lithium niobate film constituting the optical waveguide layer 20 may be an epitaxial film. Here, the epitaxial film refers to a film of single crystal grown on the substrate 10 and having the crystal orientation aligned with that of the substrate 10. That is, the so-called epitaxial film is a film whose crystal orientation is single in the film thickness direction and the film plane direction. When the film plane is set to the X-Y plane and the film thickness direction is set to the Z-axis, the crystal orientations are aligned in the X-axis, Y-axis, and Z-axis directions. Whether or not it is an epitaxial film, for example, can be proved by confirming the peak intensity and poles at the orientation position using 2θ-θ X-ray diffraction.

It is possible to form the lithium niobate film by a film forming method such as sputtering, CVD or sol-gel process. If the c-axis of the lithium niobate film is oriented perpendicular to the main surface of the substrate 10, and by applying an electric field parallel to the c-axis, the optical refractive index is changed in proportion to the intensity of the electric field. In the case of using the sapphire single crystal substrate as the substrate 10, the lithium niobate film may be formed by epitaxial growth directly on the sapphire single crystal substrate. In the case of using the silicon single crystal substrate as the substrate 10, the lithium niobate film is formed by epitaxial growth through a cladding layer. The cladding layer is made of material which has a lower refractive index than the lithium niobate film and is suitable for epitaxial growth. For example, if Y₂O₃ is used as the cladding layer, a high-quality lithium niobate film can be formed. The optical waveguide path 21 consisting of the ridge portion can be formed by patterning the lithium niobate film into a desired shape using a method such as photolithography.

By making the lithium niobate film an epitaxial film, the visible light transmittance of the lithium niobate film is improved.

To prevent the visible light propagating in the optical waveguide path 21 from being absorbed, a buffer layer (or oxide layer) 30 is formed on the optical waveguide layer 20. The buffer layer 30 preferably has a refractive index smaller than that of the optical waveguide layer 20. The buffer layer 30 is preferably a dielectric. As the material of the buffer layer 30, silicon oxide (SiO₂), aluminum oxide (Al₂O₃), lanthanum oxide (La₂O₃) or a composite of these oxides, or the like can be used. As the composite, for example, SiAlLaOx can be used. As a method of forming the buffer layer, for example, a film forming method such as sputtering, CVD sol-gel process, etc. can be used.

Preferably, the thicknesses of the buffer layers on the first ridge portion 21a, the second ridge portion 21b and the third ridge portion 21c are preferably equal. Specifically, as illustrated in FIG. 2, the thickness T7 of the buffer layer 30 on the first ridge portion 21a, the thickness T8 of the buffer layer 30 on the second ridge portion 21b and the thickness T9 of the buffer layer 30 on the third ridge portion 21c are preferably equal to each other.

According to the optical device 100 of the first embodiment, three kinds of optical waveguide paths are formed in one chip, and the propagation loss of each of the optical waveguide paths 20a, 20b and 20c can be suppressed.

FIG. 3 is an illustrative cross-sectional view of a modification 100A of the optical device 100 taken along line A-A′ of FIG. 1. As illustrated in FIG. 3, the upper surface of the buffer layer 30 is formed to have the same height, and according to the optical device 100A of the modification, the propagation loss of each of the optical waveguide paths 20a, 20b and 20c can also be suppressed.

### Second Embodiment

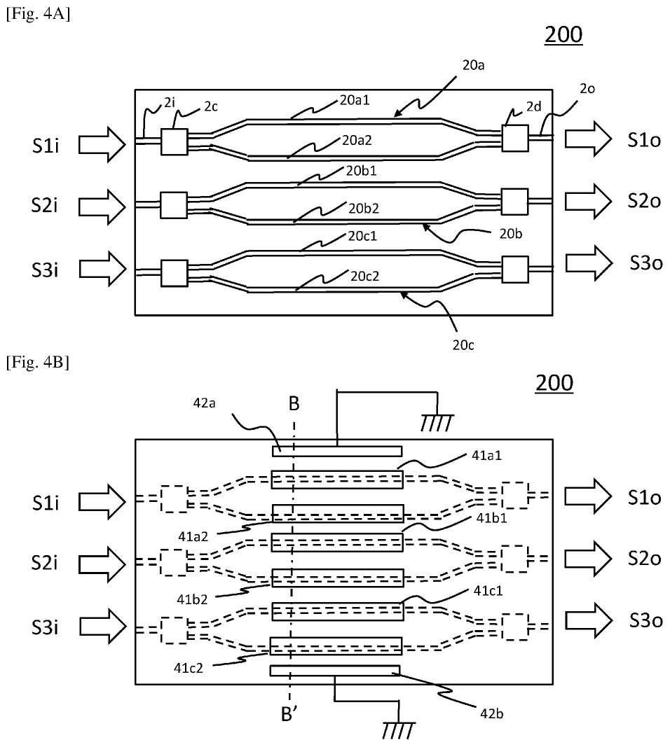

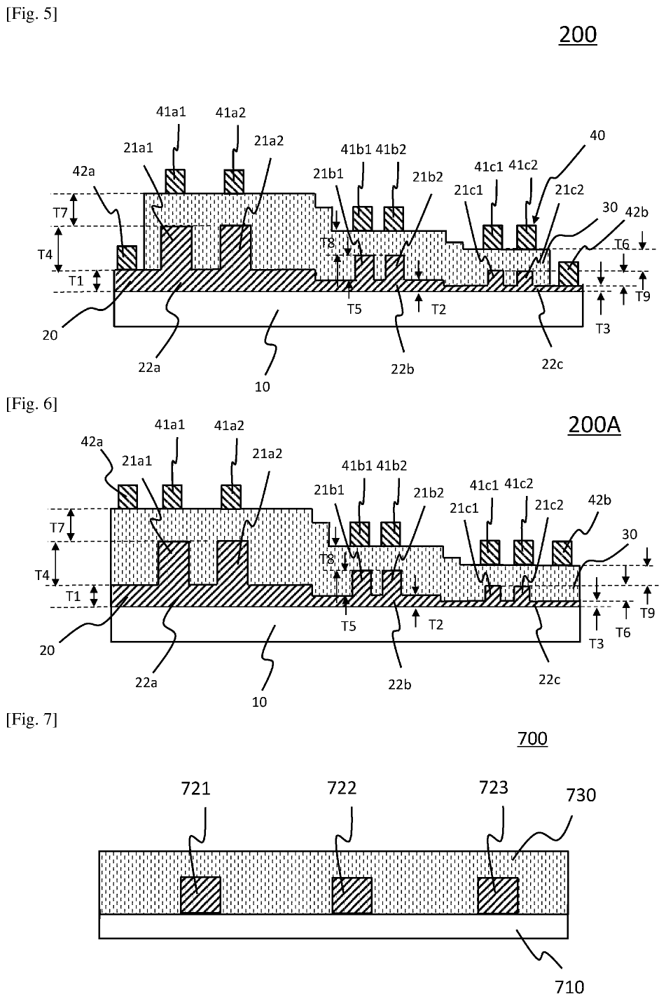

FIG. 4 is a top view of the optical device 200 of the second embodiment of the present disclosure, and FIG. 4A only illustrates the optical waveguide, and FIG. 4B illustrates the optical device 200 as a whole including the travelling wave electrode. FIG. 5 is an illustrative cross-sectional view of the optical device 200 taken along line B-B′ of FIG. 4B. The optical device 200, for example, is an optical modulator. The optical device 200 of the second embodiment is different from the optical device 100 of the first embodiment in that the first optical waveguide path 20a, the second optical waveguide path 20b and the third optical waveguide path 20c have two branched optical paths respectively. In addition, it also has signal electrodes applying modulation signals to each optical waveguide path and a ground electrode. Hereinafter, the different points are mainly described.

As illustrated in FIG. 4, the first optical waveguide path 20a, the second optical waveguide path 20b and the third optical waveguide path 20c have the same structure. Hereinafter, the first optical waveguide path 20a is described as an example. The first optical waveguide path 20a, for example, is an optical waveguide path having a structure of Mach-Zehnder interferometer, and it has a first and the second branched optical waveguide paths 20a1 and 20a2 branched by a demultiplexing section 2c from one input optical waveguide path 2i, and the first and the second branched optical waveguide paths 20a1 and 20a2 are converged in one output optical waveguide path 2o via a multiplexing section 2d. The input light S1i is demultiplexed via the demultiplexing section 2c and travels through the first and the second branched optical waveguide paths 20a1 and 20a2 respectively, and then, it is multiplexed in the multiplexing section 2d and output from the first optical waveguide path 20a as modulation light S1o.

Similarly, the second optical waveguide path 20b has a third branched optical waveguide path 20b1 and a fourth branched optical waveguide path 20b2. The third optical waveguide path 20c has a fifth branched optical waveguide path 20c1 and a sixth branched optical waveguide path 20c2.

Similar to the first embodiment, the first visible light (for example, the red visible light), as an input signal S1i, is input into the optical device 100, and after propagating in the optical waveguide path 20a, it is output as an output signal S1o. The second visible light (for example, the green visible light), as an input signal S2i, is input into the optical device 100, and after propagating in the optical waveguide path 20b, it is output as an output signal S2o. The third visible light (for example, the blue visible light), as an input signal S3i, is input into the optical device 100, and after propagating in the optical waveguide path 20c, it is output as an output signal S3o. Accordingly, the first to the third visible light can be transmitted in one device (chip).

As illustrated in FIG. 5, the first branched optical waveguide path 20a1 and the second branched optical waveguide path 20a2 are composed of the first branched ridge portion 21a1, the second branched ridge portion 21a2 and the first slab portion 22a. The third branched optical waveguide path 20b1 and the fourth branched optical waveguide path 20b2 are composed of the third branched ridge portion 21b1, the fourth branched ridge portion 21b2 and the second slab portion 22b. The fifth branched optical waveguide path 20c1 and the sixth branched optical waveguide path 20c2 arc composed of the fifth branched ridge portion 21c1, the sixth branched ridge portion 21c2 and the third slab portion 22c.

The thicknesses of the first branched optical waveguide path 20a1 and the second branched optical waveguide path 20a2 are equal, and they are both T4. The thicknesses of the third branched optical waveguide path 20b1 and the fourth branched optical waveguide path 20b2 are equal, and they are both T5. The thicknesses of the fifth branched optical waveguide path 20c1 and the sixth branched optical waveguide path 20c2 are equal, and they are both T6. In addition, the relation between the thicknesses T1 to T3 of the first slab portion 22a, the second slab portion 22b and the third slab portion 22c and the thicknesses T4 to T6 of the first and the second branched optical waveguide paths 20a1 and 20a2, the third and the fourth branched optical waveguide paths 20b1 and 20b2 and the fifth and the sixth branched optical waveguide paths 20c1 and 20c2 is the same as that of the optical device 100 of the first embodiment, and it will not be repeated here.

Similar to the optical device 100 of the first embodiment, in the optical device 200 of the second embodiment, the thickness T1 of the first slab portion 22a is smaller than the thickness T6 of the third ridge portion 21c. In other words, the thickness of the one with the largest thickness among the first slab portion 22a, the second slab portion 22b, and the third slab portion 22c is also smaller than the thickness of the smallest among the first branched ridge portion 21a1, the second branched ridge portion 21a2, the third branched ridge portion 21b1, the fourth branched ridge portion 21b2, the fifth branched ridge portion 21c1, the sixth branched ridge portion 21c2. Accordingly, the propagation loss of each of optical waveguide paths 20a, 20b and 20c can be further suppressed. Furthermore, a voltage can be easily applied to the optical waveguide paths by connecting on the thin slab portions, so that it is possible to facilitate the signal modulation and perform fine-tuning of color. In addition, since the ground electrode can be shared, the optical device can be miniaturized.

As illustrated in FIG. 5, the optical device 200 also includes an electrode layer 40. The electrode layer 40 has a plurality of signal electrodes and a plurality of ground electrodes. As the material of the electrode layer 40, for example, metals such as gold, silver, copper, platinum, ruthenium, cobalt, tungsten, molybdenum, or compounds of these metals can be used.

In order to form the electrode layer 40, for example, the following method can be used: it is possible to form the metal film by a film forming method such as evaporation, sputtering, CVD or sol-gel process, and then, it can be formed by patterning into a desired shape using a method such as photolithography. In addition, when the metal film is formed by evaporation, sputtering etc., it is also possible to form a pattern via a mask having the desired shape.

As illustrated in FIG. 5, the first signal electrode 41a1 faces the first branched ridge portion 21a1 through the buffer layer 30 in order to modulate the visible light travelling through the first branched optical waveguide path 20a1. The second signal electrode 41a2 faces the second branched ridge portion 21a2 through the buffer layer 30 in order to modulate the visible light travelling through the second branched optical waveguide path 20a2. The third signal electrode 41b1 faces the third branched ridge portion 21b1 through the buffer layer 30 in order to modulate the visible light travelling through the third branched optical waveguide path 20b1. The fourth signal electrode 41b2 faces the fourth branched ridge portion 21b2 through the buffer layer 30 in order to modulate the visible light travelling through the fourth branched optical waveguide path 20b2. The fifth signal electrode 41c1 faces the fifth branched ridge portion 21c1 through the buffer layer 30 in order to modulate the visible light travelling through the fifth branched optical waveguide path 20c1. The sixth signal electrode 41c2 faces the sixth branched ridge portion 21c2 through the buffer layer 30 in order to modulate the visible light travelling through the sixth branched optical waveguide path 20c2.

As illustrated in FIG. 4 and FIG. 5, in the top view, the first ground electrode 42a is configured along the first signal electrode 41a1 on one side of the first signal electrode 41a1 and the side of the first signal electrode 41a1 is the opposite side of the second signal electrode 41a2 side of the first signal electrode 41a1. In addition, in the top view, the second ground electrode 42b is configured along the sixth signal electrode 41c2 on one side the sixth signal electrode 41c2 and the side of the sixth signal electrode 41c2 is the opposite side of the fifth signal electrode 41c1 side of the sixth signal electrode 41c2. The first ground electrode 42a may be formed directly on the first slab portion 22a. The second ground electrode 42b may be formed directly on the third slab portion 22c. Thereby, the ground electrode can be shared, and the high frequency characteristic of the optical device 200 can be improved, and the optical device 200 can be miniaturized.

According to the optical device 200 of the second embodiment, it is possible to achieve the modulation of multiple optical paths and suppress the propagation loss of each of the optical waveguide paths 20a, 20b and 20c.

FIG. 6 is an illustrative cross-sectional view of a modification 200A of the optical device 200 taken along line B-B′ of FIG. 4B. As illustrated in FIG. 6, the first ground electrode 42a and the second ground electrode 42b are provided on the first slab portion 22a and the third slab portion 22c through the buffer layer 30. According to the optical device 200A of the modification of the second embodiment, the propagation loss of each of the optical waveguide paths 20a, 20b and 20c can be also suppressed.

### EXAMPLES

Examples 1 to 6 are prepared according to the structure of the optical device 200 of the second embodiment. The relation of the film thicknesses of the ridge portions and the slab portions in examples 1 to 6 and the path loss of each optical waveguide path are shown in Tables 1 to 6.

TABLE 1

| | First optical | Second optical | Third optical |
|---|---|---|---|
| | waveguide path | waveguide path | waveguide path |
| Input light | Red | Green | Blue |
| Film thicknesses | 0.8 | 0.7 | 0.4 |
| of ridge portions | | | |
| Film thicknesses | 0.25 | 0.20 | 0.15 |
| of slab portions | | | |
| Film thicknesses of | 0.31 | 0.29 | 0.38 |
| ridge portions/Film | | | |
| thicknesses of slab | | | |
| portions | | | |
| Path loss (dB/cm) | 1.4 | 2.5 | 0.5 |

TABLE 2

| | First optical | Second optical | Third optical |
|---|---|---|---|
| | waveguide path | waveguide path | waveguide path |
| Input light | Red | Green | Blue |
| Film thicknesses | 0.7 | 0.7 | 0.4 |
| of ridge portions | | | |
| Film thicknesses | 0.23 | 0.20 | 0.15 |
| of slab portions | | | |
| Film thicknesses of | 0.33 | 0.29 | 0.38 |
| ridge portions/Film | | | |
| thicknesses of slab | | | |
| portions | | | |
| Path loss (dB/cm) | 0.5 | 1 | 0.5 |

TABLE 3

| | First optical | Second optical | Third optical |
|---|---|---|---|
| | waveguide path | waveguide path | waveguide path |
| Input light | Red | Green | Blue |
| Film thicknesses | 0.8 | 0.6 | 0.4 |
| of ridge portions | | | |
| Film thicknesses | 0.4 | 0.3 | 0.15 |
| of slab portions | | | |
| Film thicknesses of | 0.5 | 0.5 | 0.38 |
| ridge portions/Film | | | |
| thicknesses of slab | | | |
| portions | | | |
| Path loss (dB/cm) | 20.5 | 15.5 | 0.5 |

TABLE 4

| | First optical | Second optical | Third optical |
|---|---|---|---|
| | waveguide path | waveguide path | waveguide path |
| Input light | Red | Green | Blue |
| Film thicknesses | 0.8 | 0.6 | 0.4 |
| of ridge portions | | | |
| Film thicknesses | 0.15 | 0.15 | 0.20 |
| of slab portions | | | |
| Film thicknesses of | 0.19 | 0.25 | 0.5 |
| ridge portions/Film | | | |
| thicknesses of slab | | | |
| portions | | | |
| Path loss (dB/cm) | 0.5 | 0.5 | 3.5 |

TABLE 5

| | First optical | Second optical | Third optical |
|---|---|---|---|
| | waveguide path | waveguide path | waveguide path |
| Input light | Red | Green | Blue |
| Film thicknesses | 0.7 | 0.6 | 0.4 |
| of ridge portions | | | |
| Film thicknesses | 0.15 | 0.15 | 0.10 |
| of slab portions | | | |
| Film thicknesses | 0.21 | 0.25 | 0.25 |
| of ridge portions/Film | | | |
| thicknesses of slab | | | |
| portions | | | |
| Path loss (dB/cm) | 0.5 | 0.5 | 0.5 |

TABLE 6

| | First optical | Second optical | Third optical |
|---|---|---|---|
| | waveguide path | waveguide path | waveguide path |
| Input light | Red | Green | Blue |
| Film thicknesses | 0.7 | 0.6 | 0.4 |
| of ridge portions | | | |
| Film thicknesses | 0.1 | 0.1 | 0.15 |
| of slab portions | | | |
| Film thicknesses | 0.14 | 0.17 | 0.38 |
| of ridge portions/Film | | | |
| thicknesses of slab | | | |
| portions | | | |
| Path loss (dB/cm) | 0.5 | 0.5 | 0.5 |

As illustrated in Table 1 to 6, in the case that the longer the wavelength of the light transmitted at the corresponding ridge portion is, the lower the ratio of the thickness of the slab portion to the thickness of the ridge portion is (as illustrated in Table 5 and Table 6), the path loss of the visible light with each wavelength is less than 1 dB/cm, and the effect of suppressing the propagation loss is excellent.

Although the present disclosure is described in detail above in connection with the accompanying drawings and examples, it is to be understood that the above description does not limit the present disclosure in any form. Those skilled in the art can make modifications and changes to the present disclosure as required without departing from the essential spirit and the scope of the present disclosure, and these modifications and changes all fall within the scope of the present disclosure.

### REFERENCE SIGN LIST

100, 100A, 200, 200A, 700 optical device
10 substrate
20 waveguide layer
30 buffer layer
40 electrode layer
20a first optical waveguide path
20b second optical waveguide path
20c third optical waveguide path
2c demultiplexing section
2d multiplexing section
2i input optical waveguide
2o output optical waveguide
21a first ridge portion
21b second ridge portion
21c third ridge portion
22a first slab portion
22b second slab portion
22c third slab portion

1. An optical device comprising:
a substrate; and
a plurality of optical waveguide paths formed on the substrate and comprising slab portions with different thicknesses.

2. The optical device according to claim 1, wherein the optical waveguide paths further comprise ridge portions, and among the plurality of optical waveguide paths, the thicknesses of the ridge portions are different.

3. The optical device according to claim 1, wherein oxide layer covering the plurality of optical waveguide paths is formed.

4. The optical device according to claim 2, wherein the thickness of any of the slab portions is smaller than the thickness of any of the plurality of different ridge portions.

5. The optical device according to claim 2, wherein the longer the wavelength of light transmitted at the corresponding ridge portion is, the lower the ratio of the thickness of the slab portion to the thickness of the ridge portion is.

6. The optical device according to claim 3, wherein the thicknesses of the oxide layer on the ridge portions are equal.

7. The optical device according to claim 3, wherein electrodes are provided on the oxide layer, and the electrodes are formed on a side surface of the oxide layer.

8. The optical device according to claim 3, wherein the optical waveguide paths are formed of oxides containing lithium.

9. The optical device according to claim 8, wherein the oxides containing lithium are epitaxially grown lithium niobate or lithium tantalite.
